(19) United States
(12) Patent Application Publication
(10) Pub. No.: US 2009/0116991 A1
(43) Pub. Date: May 7, 2009

(54) NOVEL Fe-Al ALLOY AND METHOD FOR PRODUCING THE SAME

(76) Inventor: Yoshihira Okanda, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/815,946

(22) PCT Filed: Feb. 10, 2006
(86) PCT No.: PCT/JP2006/302343

§ 371 Date: Sep. 4, 2008

(30) Foreign Application Priority Data
Feb. 10, 2005 (JP) 2005-35123

(51) Int. Cl. C22C 38/06; C21D 6/00; C21D 8/00

(52) U.S. Cl. 420/77; 72/365.2; 148/621; 148/645; 420/103

(57) ABSTRACT

The present invention aims to provide Fe—Al alloys having 12% by weight or less Al, which have excellent properties, such as workability, insulation properties, magnetic permeability, vibration-damping properties, high strength, etc.

Such an Fe—Al alloy is produced by the following steps of: (i) subjecting an alloy including 2 to 12% by weight Al and the balance Fe with inevitable impurities to plastic working; (ii) cold rolling the alloy which has been subjected to the plastic working; and (iii) annealing the cold-rolled alloy.

### TECHNICAL FIELD

The present invention relates to Fe—Al alloys having outstanding properties, such as workability, insulation properties, magnetic permeability, vibration-damping properties, and high strength, and a method for preparing such alloys.

### BACKGROUND OF THE INVENTION

Heretofore, Fe—Cr—Al alloys, Mn—Cu alloys, Cu alloys, Mg alloys, etc., are known as metals having vibration-damping properties and/or workability, and are used for various applications. Among the above, it is known that an Fe—Al alloy having 6 to 10% by weight Al and an average crystal grain diameter of 300 to 700 μm exhibits outstanding vibration-damping properties, and is useful as a vibration damping alloy (e.g., Japanese Unexamined Patent Publication No. 2001-59139). Such an Fe—Al alloy is produced by cooling an alloy, which has been subjected to plastic working and annealing, at a predetermined cooling rate.

However, any other methods for producing an Fe—Al alloy comprising about 12% by weight or lower Al are hardly known. In addition, it is not completely known which technical processes should be adopted to further improve the useful properties and increase utility values of the Fe—Al alloy, whose Al content is about 12% by weight or lower.

### DISCLOSURE OF THE INVENTION

### Problem to be Solved by the Invention

The present invention aims to provide an alloy which is an Fe—Al alloy comprising 12% by weight or lower Al and which has further excellent properties, such as workability, insulation properties, magnetic permeability, vibration-damping properties, high strength, etc.

### Means for Solving the Problem

The present inventors carried out intensive research in order to achieve the above-described objects, and found that it is possible to obtain an Fe—Al alloy whose average crystal grain diameter is 250 μm or lower and whose structure is different from that of hitherto-known Fe—Al alloys by subjecting an alloy, comprising 2 to 12% by weight Al with the balance Fe with inevitable impurities, to plastic working, a cold rolling process, and then an annealing process. The Fe—Al alloys of the invention have new properties different from hitherto-known Fe—Al alloys, and are especially excellent in workability, insulation properties, magnetic permeability, vibration-damping properties, high strength, etc. The present invention has been accomplished by carrying out further research based on these findings.

More specifically, the present invention provides the following methods for producing an Fe—Al alloy, and the Fe—Al alloy obtained by the method.

Item 1. A method for producing an Fe—Al alloy comprising the following steps of:

(i) subjecting an alloy comprising 2 to 12% by weight Al and a balance Fe with inevitable impurities to plastic working;

(ii) cold rolling the alloy which has been subjected to the plastic working; and

(iii) annealing the cold-rolled alloy.

Item 2. A method according to item 1, wherein the cold rolling process in step (ii) is performed in such a manner that a reduction in area becomes 5% or higher.
Item 3. A method according to item 1, wherein the annealing process in step (iii) is performed at temperatures of 400 to 1200° C.

Item 4. An Fe—Al alloy produced by the following steps of:

(i) subjecting an alloy comprising 2 to 12% by weight Al and a balance Fe with inevitable impurities to plastic working;

(ii) cold rolling the alloy which has been subjected to the plastic working; and

(iii) annealing the cold-rolled alloy.

Item 5. An Fe—Al alloy, comprising 2 to 12% by weight Al and a balance Fe with inevitable impurities and having an average crystal grain diameter of 250 mW or lower.
Item 6. An Fe—Al alloy according to item 5 having an average crystal grain diameter of 10 to 40 μm.
Item 7. An Fe—Al alloy according to item 5 used as a vibration-damping alloy or an insulation alloy.

### BRIEF DESCRIPTION OF THE DRAWINGS

FIG. 1 is a diagram showing the differential scanning calorimetric analysis results (DSE curve) of Fe—Al alloys having the formulae 1 to 6 which were cold rolled at a reduction in area of 5% in Reference Example 1.

FIG. 2 is a diagram showing the differential scanning calorimetric analysis results (DSE curve) of Fe—Al alloys having the formulae 1 to 6 which were cold rolled at a reduction in area of 10% in Reference Example 1.

FIG. 3 is a diagram showing the differential scanning calorimetric analysis results (DSE curve) of Fe—Al alloys having the formulae 1 to 6 which were cold rolled at a reduction in area of 20% in Reference Example 1.

FIG. 4 is a diagram showing the differential scanning calorimetric analysis results (DSE curve) of Fe—Al alloys having the formulae 1 to 6 which were cold rolled at a reduction in area of 50% in Reference Example 1.

FIG. 5 is a photograph showing the test results of Example 1 in which the Fe—Al alloy of the present invention was processed at high speeds at 200° C. to be formed into the shape of a frying pan.

FIG. 6 is a photograph showing the test results of Example 1 in which the Fe—Al alloy of the present invention was fractured with a tensile testing machine at a temperature of 200° C., and the fractured section was observed under a microscope.

FIG. 7 is a diagram showing the test results of Example 3, i.e., the relationship between the annealing temperature during an annealing process after cold rolling and the tensile strength (tensile strength MPa) of the Fe—Al alloy of the present invention.

FIG. 8 is a diagram showing the test results of Example 3, i.e., the relationship between the annealing temperature during an annealing process after cold rolling and the elongation degree (%) of the Fe—Al alloy of the present invention.

FIG. 9 is a diagram showing the test results of Example 4, i.e., the relationship between the annealing temperature during an annealing process after cold rolling and the hardness (hardness HV0.3) of the Fe—Al alloy of the present invention.

FIG. 10 is a diagram showing the test results of Example 5, i.e., the specific-resistances ρ (mm·Ohm) within the range of −40 to 160° C. of the Fe—Al alloy of the present invention and mild steel.

FIG. 11 shows the test results of Example 6.

FIG. 11(A) shows the magnetization curve of pure iron and FIG. 11(B) shows the magnetic permeability curves of the Fe—Al alloy of the present invention, comparative alloy 1, and comparative alloy 2.

FIG. 12 shows the test results of Example 7. More specifically, FIG. 12 shows the vibration-damping characteristics of the Fe—Al alloy of the present invention produced at a cooling rate of 5° C./min or 1° C./min after the annealing process. In FIG. 12, the vertical axis represents a loss coefficient and the horizontal axis represents strain amplitude.

FIG. 13 is a micrograph of the observed detailed structure of each Fe—Al alloy in Example 8. FIG. 13a) shows a micrograph of a comparative alloy 4, FIG. 13b) shows a micrograph of an alloy which was annealed at 600° C., FIG. 13c) shows a micrograph of an alloy which was annealed at 700° C., FIG. 13d) shows a micrograph of an alloy which was annealed at 800° C., FIG. 13e) shows a micrograph of an alloy which was annealed at 850° C., FIG. 13f) shows a micrograph of an alloy which was annealed at 9000C.

### BEST MODE FOR CARRYING OUT THE INVENTION

Hereinafter, the present invention will be described in detail.

The Fe—Al alloy produced in the present invention comprises 2 to 12% by weight Al and the balance Fe with inevitable impurities (0.1% by weight or lower Si; 0.1% by weight or lower Mn; 0.1% by weight or lower of a total amount of C, N, S, O, etc.).

The Al content may be within the range of 2 to 12% by weight, preferably 6 to 10% by weight, and more preferably 7 to 9% by weight. The Al content is suitably determined within the above range according to strength, workability, insulation properties, magnetic permeability, vibration-damping properties, etc.

Hereafter, the method for producing the Fe—Al alloy of the present invention, properties of the Fe—Al alloy of the present invention, etc., will be described.

### (I) Method for Producing an Fe—Al Alloy

Hereafter, each step of the method for producing the Fe—Al alloy of the present invention will be described in detail.

### Step (i)

According to the method for producing the Fe—Al alloy of the present invention, first, an alloy comprising 2 to 12% by weight Al and the balance Fe with inevitable impurities is subjected to a plastic process (step (i)). More specifically, first, Al and Fe materials, which are previously adjusted in such a manner that the Al content in the Fe—Al alloy to be produced is a predetermined value, are melted under a reduced pressure of about 0.1 to 0.01 Pa in order to prevent invasion of nitrogen and oxygen, and the molten Fe and Al material is poured into a mold to thereby obtain an Fe—Al alloy ingot. Thereafter, the obtained alloy ingot is formed into a predetermined shape by rolling, plastic working, such as forging, and a machining process.

If required, the alloy which has been subjected to plastic working may be annealed after the plastic working. By performing the annealing process after the plastic working as described above, alloy performances, such as workability, vibration-damping properties, high strength, etc., can be improved. When annealing is performed after plastic working, the annealing conditions are not limited. For example, the alloy obtained after plastic working is maintained at temperatures of about 700° C. to 1000° C. for about 30 minutes to about 2 hours. The annealing temperature and annealing period may be suitably selected from the above range considering the formula, plastic working conditions, and the like of alloy.

### Step (ii)

Subsequently, the alloy which has been subjected to plastic working is cold rolled (step (ii)).

When the annealing process is performed after the plastic working, the cold rolling process is performed after the alloy is cooled to temperatures (described below) suitable for the cold rolling process. There is no limitation on the temperatures suitable for the cold rolling process insofar as the temperature is the recrystallizing temperature of the target alloy or lower, and the cold rolling process can be usually carried out at room temperature. The rolling conditions for the cold rolling process are not limited. It is desirable that a reduction in area is usually 5% or more, preferably 20% or more, and more preferably 20 to 95%. By performing the rolling process in such a manner as to yield a reduction in area within the above range, it becomes possible to impart a short range ordered structure to the alloy. In this step, the alloy may be processed to achieve the above-mentioned reduction in area by a single cold rolling process, or may be processed by performing the cold rolling process twice or more to achieve the above-mentioned reduction in area. In the specification, the “reduction in area” refers to a reduced proportion (%) of a sectional area of the alloy after the rolling process relative to the sectional area of the alloy before the rolling process. The “reduction in area” can be calculated according to the following formula.

Reduction in area (%)=[1−(cross-sectional area of an alloy after processing)/(cross sectional area of alloy before processing)]×100 [Formula 1]

Step (iii)

Subsequently, the cold-rolled alloy is annealed (step (iii)). More specifically, the obtained cold-rolled alloy is held at temperatures of about 400 to about 1200° C. (preferably 600 to 1000° C., more preferably 600 to 850° C.) for about 30 minutes to about 2 hours for annealing. The annealing temperature and annealing period may be suitably selected from the above range considering the formula, plastic working conditions, and the like of the alloy.

There is no limitation on the rate at which the annealed alloy is cooled. The cooling rate can be suitably determined according to the annealing temperature, degree of internal stress of the alloy, etc. From the viewpoint of imparting further excellent strength, vibration-damping properties, and like properties to the Fe—Al alloy to be obtained, it is preferable that the alloy, which has been annealed under the above-mentioned conditions, is cooled at a cooling rate of 10° C./minute or lower, preferably 1° C. to 5° C./minute or lower, within the temperature range up to 600° C., and is naturally cooled (allowed to cool) within the temperature range of 600° C. or lower.

### (II) Fe—Al Alloy

The Fe—Al alloy produced by the above-described production process has high strength and is excellent in properties, such as workability, insulation properties, magnetic permeability, vibration-damping properties, etc. and can be applied in various fields.

The Fe—Al alloy of the invention is useful as, high strength materials, for example, automobiles based on the outstanding workability of the alloy. The Fe—Al alloy of the invention is useful as an insulation alloy for use in, for example, core materials of motors and the like based on the outstanding insulation properties of the alloy. In addition, the Fe—Al alloy of the invention is useful as a magnetic permeable alloy for use in, for example, various electromagnetic materials and the like based on the outstanding magnetic permeability of the alloy. In addition, the Fe—Al alloy of the invention is easy to heat and is hard to cool, and thus is useful also as IH cooker. Moreover, the Fe—Al alloy of the invention is, based on the outstanding vibration-damping properties of the alloy, useful as, for example, a vibration damping alloy for use in automobile body materials, bearings, press shims of die, tool materials, DVD casings, speaker components, members for precision mechanical equipment, vibration-damping bushes, sport equipment (e.g., tennis racket grips and the like), etc.

The Fe—Al alloy of the invention has the above-described properties, and has properties different from hitherto-known Fe—Al alloys comprising 12% by weight or less Al. The experimental data was obtained which suggests that the atoms in the alloy are regularly arranged locally by performing the annealing process after the cold rolling process. It is predicted based on the experimental data that the Fe—Al alloy of the invention has a short-range ordered structure; hitherto-known Fe—Al alloys comprising 12% by weight or less Al do not have such a structure. Owing to the short-range ordered structure in the alloy, it is inferred that the Fe—Al alloy of the invention is imparted with properties different from hitherto-known Fe—Al alloys comprising 12% by weight or less Al.

The Fe—Al alloy obtained by the above-described production process has an average crystal grain particle diameter of 250 μm or lower, and has a smaller crystal grain diameter compared with hitherto-known Fe—Al alloys. More specifically, the present invention provides an Fe—Al alloy which comprises 2 to 12% by weight Al and the balance Fe with inevitable impurities and which has an average crystal grain diameter of 250 μm or less. In the Fe—Al alloy of the invention, the average crystal grain diameter is preferably 1 to 100 μm and more preferably 10 to 40 μm. Thus, owing to the crystal grains having such a small average particle diameter, the strength of the alloy is increased and properties, such as workability, insulation properties, magnetic permeability, vibration-damping are further improved. In the present invention, the average crystal grain diameter of the Fe—Al alloy is measured in accordance with “Austenite grain size test for steel” specified in JIS G0551.

The average particle diameter of the crystal grain particles of the Fe—Al alloy of the invention is adjusted by suitably setting the cold rolling conditions of step (ii), the annealing conditions of step (iii), etc., in the above-described production method. For example, as the reduction in area is more increased in the cold rolling process of step (ii), the average particle diameter of the crystal grains of the Fe—Al alloy becomes smaller. For example, as the annealing temperature in the annealing process of step (iii) increases, the average particle diameter of crystal grains of the Fe—Al alloy becomes larger.

### EXAMPLES

The present invention will be described with reference to the following examples, but is not limited thereto.

### Reference Example 1

A given amount of electrolytic iron and 99.99% by weight Al were weighed in such a manner as to yield the Al contents (formulae 1 to 6) shown in Table 1, and subjected to high frequency melting using a porous Tammann tube. After being melted, the resultant was injected into a transparent quartz tube with an inner diameter φ of 4 mm, and solidified to thereby give rod-like alloy samples. The rod-like alloy samples were hot rolled at 900° C., and subjected to plastic working to give a sheet shape (thickness 1 mm×2 mm×30 mm), followed by annealing at 900° C. for 1 hour. After the annealing process, the resultant was cooled to 550° C. at a cooling rate of 1° C./minute, and cold rolled at room temperature at a reduction in area of 5, 10, 20, or 50%.

TABLE 1

| | Al content (% by weight) |
|---|---|
| Formula 1 | 2.5 |
| Formula 2 | 5.1 |
| Formula 3 | 7.9 |
| Formula 4 | 10.8 |
| Formula 5 | 13.9 |
| Formula 6 | 17.2 |

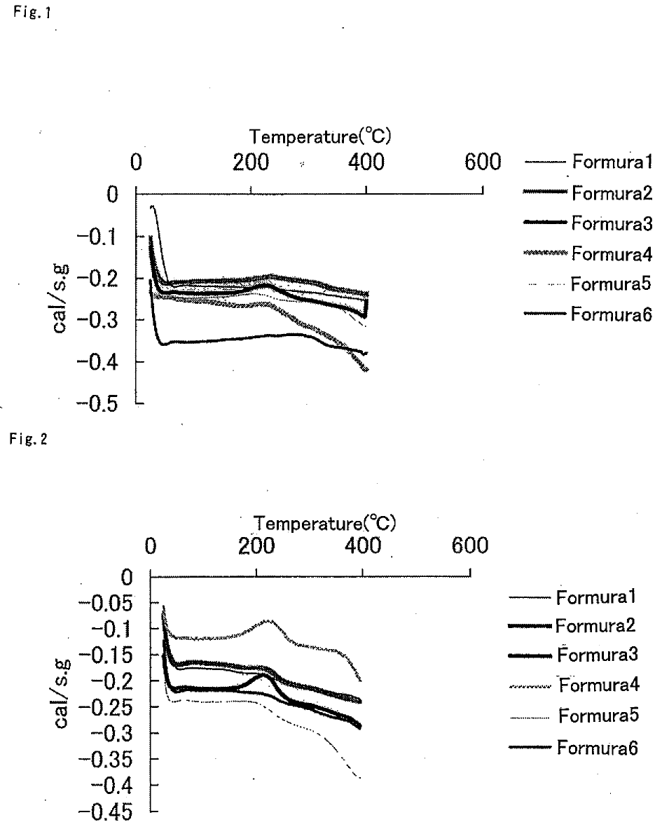

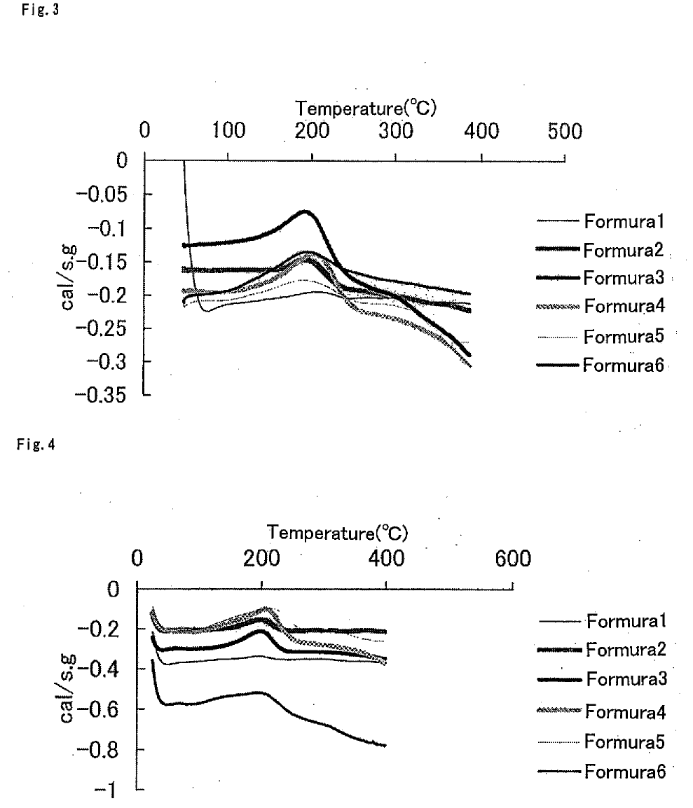

The Fe—Al alloys thus obtained after cold rolling were heated using a differential scanning calorimeter (DSC). At the same time, the generation of thermal energy during heating was measured. To be specific, using a differential scanning calorimeter (manufactured by Rigaku Corporation), the generation of thermal energy at temperatures of 50 to 300° C. at a heating rate of 0.33° C./second was measured. The obtained results are shown in FIGS. 1 to 4. FIGS. 1, 2, 3, and 4 show the cases where the reduction in area is 5%, 10%, 20%, and 50%, respectively. Considering that it was confirmed by analysis with a differential scanning calorimeter that the peak (maximum) generation of thermal energy appeared near 230° C. in the alloys of formulae 1 to 4 that were subjected to cold working at a reduction in area of 5 to 50% and then heated after the plastic working and annealing, it is predicted based on these results that the atomic arrangement of the Fe—Al alloy changed during heating and the Fe—Al alloy was imparted with a short-range ordered structure. As the reduction in area increases, the variation in the thermal energy confirmed by analysis with a differential scanning calorimeter increases. Based on this, it was suggested that the degree of the short-range ordered structure in the Fe—Al alloy is improved by performing the cold rolling process in such a manner as to increase the reduction in area.

### Example 1

### Evaluation of Working Properties

A given amount of pure iron and 99.9% by weight Al were weighed in such a manner as to yield 8% by weight Al alloy, and subjected to high frequency vacuum melting (final formula; Al: 7.78% by weight, C: 0.004% by weight, Si: 0.02% by weight, Mn: 0.05% by weight, P: 0.005% by weight, S: 0.002% by weight, Cr: 0.02% by weight, Ni: 0.05% by weight, and Fe: balance). After melting, hot working was performed to an area of 200×100×4000 mm at 1100° C., and the resultant was partially cut. The cut part was hot-rolled at 1100° C. to yield a thickness of 4 mm. Subsequently, the resultant was annealed at 700° C. for 1 hour, and air cooled to room temperature. The cooled alloy was cold rolled at 20° C. to yield a reduction in area of 50%. Subsequently, the resultant was annealed at 800° C. for 1 hour, and air cooled to 600° C. at a cooling rate of 1° C./minute.

The Fe—Al alloy thus obtained was processed at 200° C. at high speed, and was formed into the shape of a frying pan. As a result, the Fe—Al alloy was easily formed into the shape of a frying pan with no problems, such as cracking (see FIG. 5). In contrast, when an Fe—Al alloy (2 mm in thickness) which had the same formula as the above but had not been subjected to cold working was processed at a high speed under the same conditions to be formed into the shape of a frying pan, a crack was formed in the processed item.

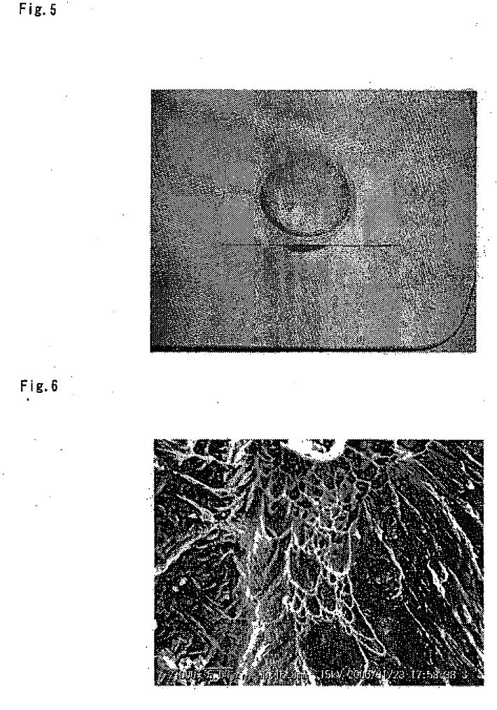

The Fe—Al alloy thus obtained was elongated with a tensile tester at 200° C. until the Fe—Al alloy was broken. When the broken cross section was observed under a microscope, dimples were observed in the broken cross section. Considering this, it was confirmed that the Fe—Al alloy of the invention has excellent working properties (see FIG. 6).

The above results confirmed that the Fe—Al alloy of the invention is excellent in workability, and can be subjected to strong processing in warm at about 200° C.

### Example 2

### Evaluation of Strength

In order to evaluate the strength of the Fe—Al alloy prepared according to the method described in Example 1 above, the tensile strength and elongation were measured in accordance with the following methods. More specifically, the tensile strength and elongation were measured at temperatures of −30° C., 26° C., and 160° C. with an Instron type universal testing machine (5582 model, product of Instron) (n=2). A comparative Fe—Al alloy was prepared following the procedure of Example 2 above except that the alloy was annealed at 900° C. for 1 hour without a cold rolling process, cooled to 500° C. at a cooling rate of 1° C./minute, and further allowed to cool to room temperature (Comparative-Example 1).

The obtained results are shown in Table 2. The results clarified that the Fe—Al alloy of the invention has high tensile strength within a wide range of temperatures from −30° C. to 160° C., and has outstanding strength. In particular, it was confirmed that the Fe—Al alloy of the invention is notably excellent in elongation as compared with the alloy of Comparative Example 1.

TABLE 2

| | | | | | Comparative |
|---|---|---|---|---|---|
| | | Example | | | Example 1 |
| Temperature for mea- | | −30° C. | 26° C. | 160° C. | 26° C. |
| suring tensile strength | | | | | |
| and elongation | | | | | |
| Tensile | Strength | 491-500 | 525-545 | 433-488 | 500 |
| strength | Elongation | 13.4-18.8 | 37.2-46.5 | 42.5-43.0 | 13.0 |

### Example 3

### Evaluation of Strength

An Fe—Al alloy was prepared following the procedure of Example 1 except that annealing was performed at various annealing temperatures of 500° C. to 1200° C. after cold working. The tensile strength (ultimate tensile strength), yield strength, and elongation of each of the obtained Fe—Al alloys were measured in the same manner as in Example 2 above.

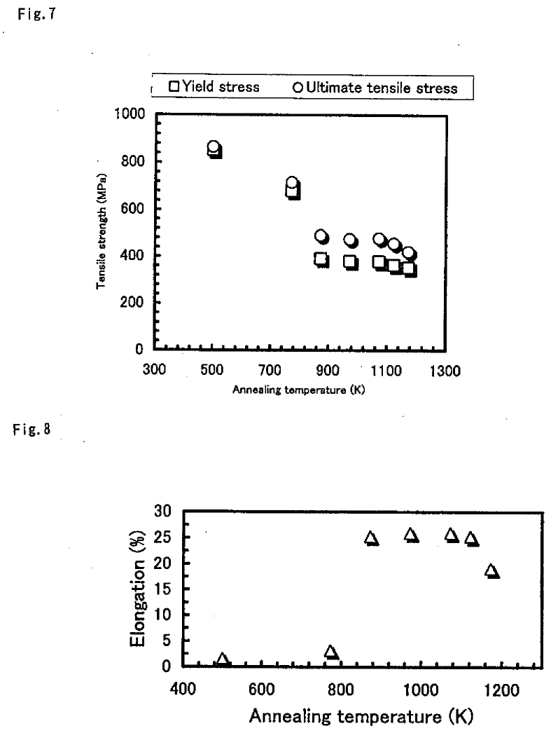

The obtained results are shown in FIG. 7 (tensile strength and yield strength) and FIG. 8 (elongation). The results confirmed that the Fe—Al alloy of the invention, which was produced by setting the annealing temperature to 800 K (523° C.) or lower, is imparted with further excellent tensile strength.

### Example 4

### Evaluation of Hardness

An Fe—Al alloy was prepared following the procedure of Example 1 above except that annealing was performed at various annealing temperatures of 500° C. to 12000C after cold working. The hardness (Hardness HV0.3) of each of the obtained Fe—Al alloys was measured with a Vickers hardness tester (Akashi Seisakusho, Ltd).

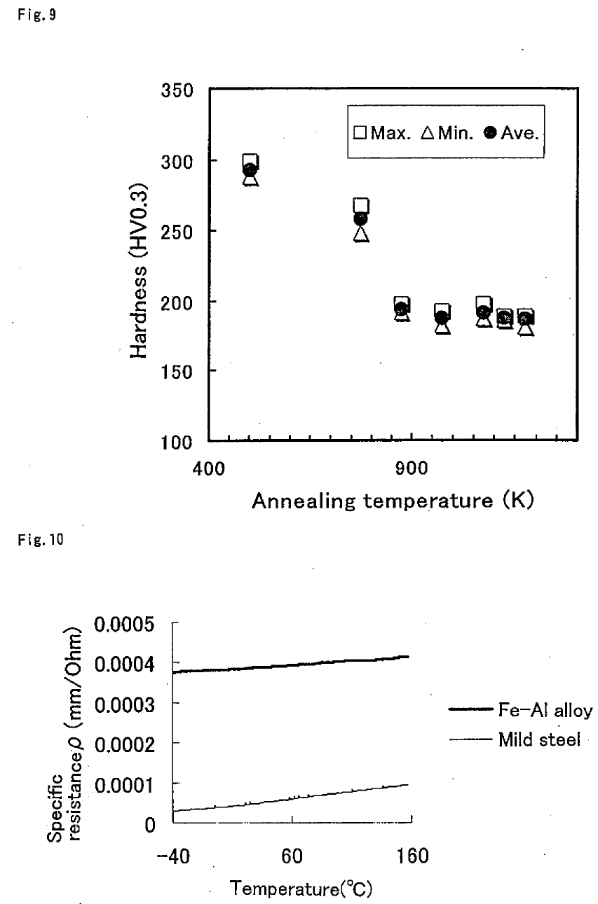

The obtained results are shown in FIG. 9. The results confirmed that the Fe—Al alloy of the invention is excellent also in terms of hardness, and that an alloy having higher hardness is obtained by setting the annealing temperature to 800 K (523° C.) or lower.

### Example 5

### Evaluation of Insulation Properties

In order to evaluate the insulation properties of the Fe—Al alloy prepared in accordance with the method described in Example 1 above, the specific resistance ρ (mm·Ohm) within the range of −40° C. to 160° C. was measured using a four-terminal method. For comparison, a generally-used mild steel for automobiles was measured for the specific resistance.

The measurement results are shown in FIG. 10. The results confirmed that the Fe—Al alloy of the invention has a specific resistance about seven times that of the mild steel, and moreover, the specific resistance is unsusceptible to temperature change, and thus the insulation properties of the alloy are excellent.

### Example 6

### Evaluation of Magnetic Permeability

Following the procedure of Example 1 above, an Fe—Al alloy was prepared. In order to evaluate the magnetic permeability of the Fe—Al alloy, an Electron Magnet For V.S.M (product of Toei Kogyo) was used to obtain a magnetization curve (in FIG. 11, referred to as the Fe—Al alloy of the invention). For comparison, an alloy (comparative alloy 1) was produced following the procedure of Example 1 above except that the alloy was rolled at 300° C., instead of performing a cold rolling process, and annealing process, and an alloy (comparative alloy 2) was prepared following the procedure of Example 1 above, except that an alloy was rolled at 600° C. instead of performing a cold rolling process and annealing process. Then, magnetization curves for the comparative alloy 1, comparative alloy 2, and pure iron were obtained.

The obtained results are shown in FIG. 11. The results confirmed that the Fe—Al alloy of the invention has higher magnetic permeability compared with pure iron (i.e., the inclination of the magnetization curve is steep) and has more excellent magnetic permeability compared with pure iron. The Fe—Al alloy of the invention also has higher magnetic permeability compared with the comparative alloy 1 and comparative alloy 2. Thus, it was clarified that the cold rolling process during production contributed to improving magnetic permeability.

### Example 7

### Evaluation of Vibration-Damping Properties

An Fe—Al alloy was prepared following the procedure of Example 1 above except that the alloy was allowed to cool by setting the cooling rate of the annealing process after cold working to 5° C./minute (cooling condition 1) or 1° C./min (cooling condition 2). In order to evaluate the vibration-damping properties of each of the obtained Fe—Al alloys, the following test was performed. For comparison, an Fe—Al alloy (comparative alloy 3) which had the same formula as that of the above Fe—Al alloy and which was produced by subjecting an alloy to hot rolling, annealing at 900° C. for 1 hour, and furnace cooling was similarly evaluated for vibration-damping properties.

Vibration-damping properties were evaluated using a transverse vibration method. More specifically, a strain gauge was adhered to one end (130 mm from the other end) of a sheet of each of the Fe—Al alloys (0.8×30×300 mm), and the resultant was connected to a strain meter. The other end of the Fe—Al alloy sheet was fixed with a vise to form a cantilever having a free length of 150 mm. Free vibration was induced in the Fe—Al alloy sheet, and strain was detected from the strain gage, to thereby obtain a curve of damping capacity with strain decaying. An accelerometer was also attached and the curve was obtained in terms of acceleration.

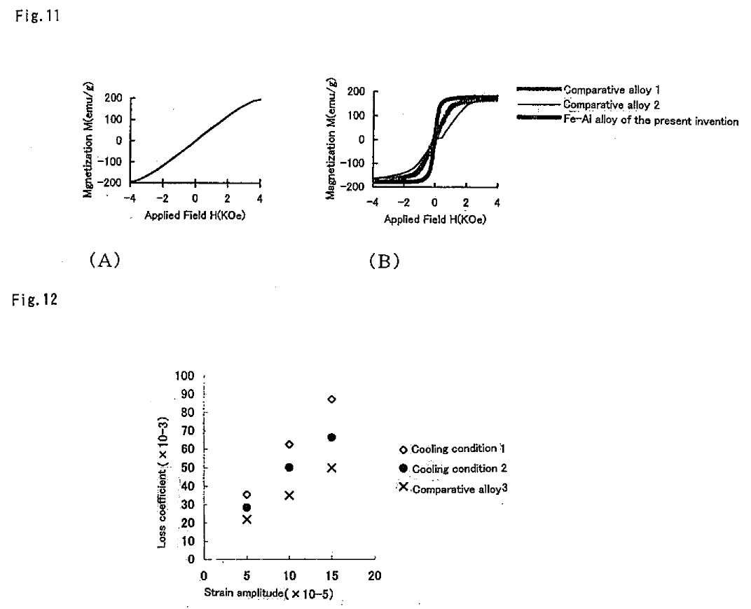

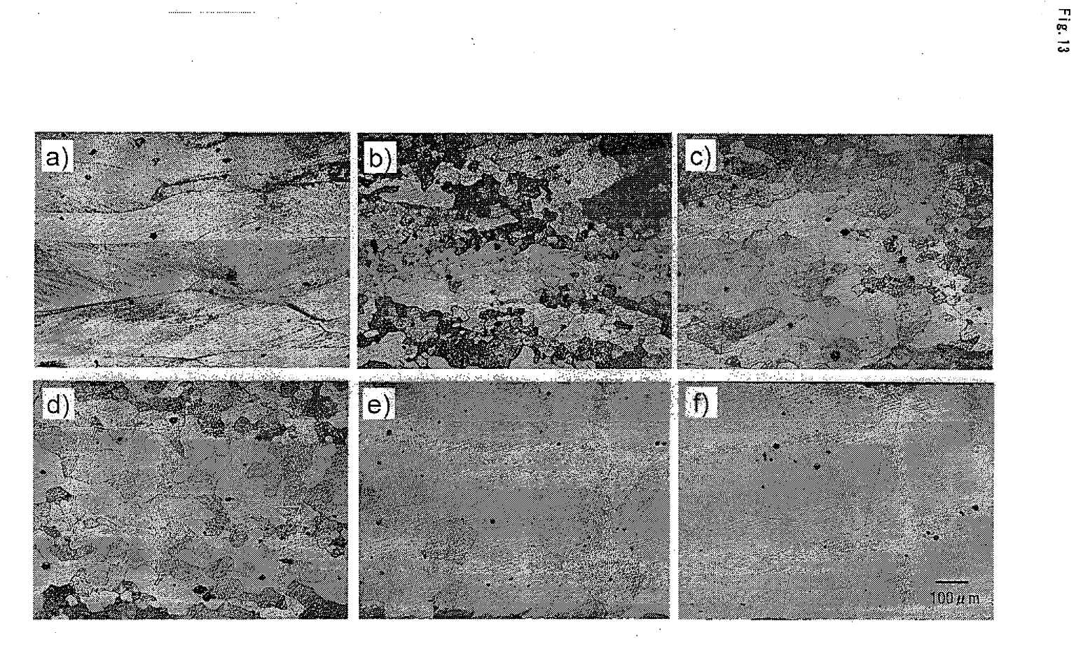

The obtained results are shown in FIG. 12. The results confirmed that as the cooling rate after annealing is slower, the obtained alloy exhibits more outstanding vibration-damping properties. It was also confirmed that the Fe—Al alloy of the present invention has outstanding vibration-damping properties compared with the Fe—Al alloy (comparative alloy 3) which was annealed at 900° C. without cold-rolling.

### Example 8

### Observation of a Detailed Structure-1

An Fe—Al alloy was prepared following the procedure of Example 1 above except annealing after cold working was performed at one of various annealing temperature of 600, 700, 800, 850, and 900° C. The detailed structure of each of the obtained Fe—Al alloys was observed under a metallographic microscope. For comparison, the detailed structure of an Fe—Al alloy (comparative alloy 4) which was not annealed after cold rolling was similarly observed under a metallographic microscope.

The obtained results are shown in FIG. 13. The results confirm that the grain particle diameter of the alloy decreases by annealing the alloy after cold rolling. FIG. 13 clarifies that the average particle diameter of the Fe—Al alloy of the present invention is 250 μm or lower even when it was annealed at 800° C.

In addition, it was confirmed that the Fe—Al alloy annealed at 600 to 800° C. after cold rolling had a fine structure. The test results and the results of Example 3 (FIG. 8) suggest that the elongation degree of the Fe—Al alloy tends to increase as the alloy structure becomes finer.

### Example 9

### Observation of a Detailed Structure-2

An Fe—Al alloy was prepared following the procedure of Example 1 except that the reduction in area during cold working was adjusted to 92.5%, 85%, or 60% for processing.

The average crystal grain diameter of each of the obtained Fe—Al alloys was measured in accordance with “Austenite grain size test for steel” specified in JIS G0551. Each of the obtained Fe—Al alloys was measured for the tensile strength in the same manner as in Example 2 (measured at 20° C.). Each of the obtained Fe—Al alloys was bent by 180° in such a manner that the bending radius was three times of the plate thickness, and the existence of cracks on the outer side of the bent test piece was checked.

The obtained results are shown in Table 3. The prepared Fe—Al alloys all had an average grain particle diameter of 250 μm or lower. The results confirmed that an Fe—Al alloy with a small grain particle diameter is obtained by increasing the reduction in area during cold working. In addition, it was clarified that as the grain particle diameter of the Fe—Al alloy decreases, the Fe—Al alloys can be imparted with excellent properties, such as strength and/or bending properties.

TABLE 3

| | | Examples | | |
|---|---|---|---|---|
| Preparation | Reduction in | 92.5% | 85% | 60% |
| conditions | cross section | | | |
| | area during | | | |
| | cold rolling | | | |
| Alloy | Average grain | 30 μm | 100 μm | 230 μm |
| properties | particle diameter | | | |
| | Tensile strength | 800 Mpa | 600 Mpa | 560 Mpa |
| | (Mpa) | | | |
| | Bending | No breaking | No breaking | Slight |
| | | and excellent | and excellent | breaking |
| | | elongation | elongation | |
| | | properties | properties | |

### INDUSTRIAL APPLICABILITY

According to the present invention, Fe—Al alloy can be imparted with outstanding workability, insulation properties, magnetic permeability, vibration-damping properties, high strength, etc., by adjusting the average grain particle diameter of an Fe—Al alloy comprising 2 to 12% by weight Al to 250 μm or less. Therefore, the present invention can provide alloys which can be applied in various fields and are extremely useful, compared with hitherto-known Fe—Al alloys.

1. A method for producing an Fe—Al alloy comprising the following steps of:
(i) subjecting an alloy comprising 2 to 12% by weight Al and a balance Fe with inevitable impurities to plastic working;
(ii) cold rolling the alloy which has been subjected to the plastic working; and
(iii) annealing the cold-rolled alloy.

2. A method according to claim 1, wherein the cold rolling process in step (ii) is performed in such a manner that a reduction in area becomes 5% or higher.

3. A method according to claim 1, wherein the annealing process in step (iii) is performed at temperatures of 400 to 1200° C.

4. An Fe—Al alloy produced by the following steps of:
(i) subjecting an alloy comprising 2 to 12% by weight Al and a balance Fe with inevitable impurities to plastic working;
(ii) cold rolling the alloy which has been subjected to the plastic working; and
(iii) annealing the cold-rolled alloy.

5. An Fe—Al alloy, comprising 2 to 12% by weight Al and a balance Fe with inevitable impurities and having an average crystal grain diameter of 250 μm or lower.

6. An Fe—Al alloy according to claim 5 having an average crystal grain diameter of 10 to 40 μm.

7. An Fe—Al alloy according to claim 5 used as a vibration-damping alloy or an insulation alloy.
